(19) United States
(12) Patent Application Publication
(10) Pub. No.: US 2009/0150727 A1
(43) Pub. Date: Jun. 11, 2009

(54) DATA TRANSMISSION METHOD

(75) Inventors: Shih-Hao Huang, Tu-Cheng (TW); Fei-Hsu Chen, Tu-Cheng (TW); Han-Chieh Chang, Tu-Cheng (TW); Chau-Lin Chang, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/048,219

(22) Filed: Mar. 14, 2008

(30) Foreign Application Priority Data
Dec. 7, 2007 (CN) 200710202922.0

(51) Int. Cl. G06F 11/00

(52) U.S. Cl. 714/52; 714/E11.001

(57) ABSTRACT

An exemplary data transmission method is used in a data transmission system which has a data source, a data receiver, first, second, and third transmission lines connected between the data source and the data receiver. The data transmission method includes: the data source generating a checking code of a first byte and a second byte; transmitting the first byte, the second byte and the checking code from the data source to the data receiver via the first, second, and third transmission lines respectively; and the data receiver judging if the first byte, the second byte and the checking code are right, if right, transmission of the first byte and the second byte is complete, if one of the first byte and the second byte is wrong, and the checking code is right, the data receiver corrects the wrong byte via the checking code.

### BACKGROUND

1. Field of the Invention

The present invention relates to a data transmission method used in data transmission systems.

2. Description of Related Art

In data transmission systems there is always a certain probability of error due to external interference. Conventionally, eight bits (one byte) of data is transmitted via a transmission line at a time, and an error correcting code (ECC) is used to detect errors in the transmitted byte, if there is an error, the byte should be transmitted as many times as necessary until the byte is confirmed to be correct, this method of transmission is unduly slow.

What is needed, therefore, is a data transmission method which can solve the above mentioned problems.

### SUMMARY

An exemplary data transmission method is used in a data transmission system which has a data source, a data receiver, first, second, and third transmission lines connected between the data source and the data receiver. The data transmission method includes: the data source generating a checking code of a first byte and a second byte; transmitting the first byte, the second byte and the checking code from the data source to the data receiver via the first, second, and third transmission lines respectively; and the data receiver judging if the first byte, the second byte and the checking code are right, if right, transmission of the first byte and the second byte is complete, if one of the first byte and the second byte is wrong, and the checking code is right, the data receiver corrects the wrong byte via the checking code.

Other advantages and novel features of the present invention will become more apparent from the following detailed description of preferred and exemplary embodiment when taken in conjunction with the accompanying drawings, in which:

### BRIEF DESCRIPTION OF THE DRAWINGS

FIG. 1 is a circuit diagram of a data transmission system actualizing a data transmission method in accordance with an embodiment of the present invention; and

FIG. 2 is a flow chart of the data transmission method.

### DETAILED DESCRIPTION

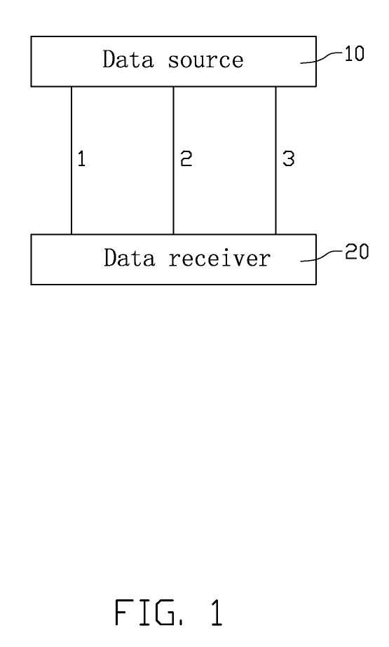

Referring to FIG. 1, a data transmission system actualizing a data transmission method in accordance with an embodiment of the present invention includes a data source 10, a data receiver 20, and three transmission lines 1, 2 and 3 connected between the data source 10 and the data receiver 20.

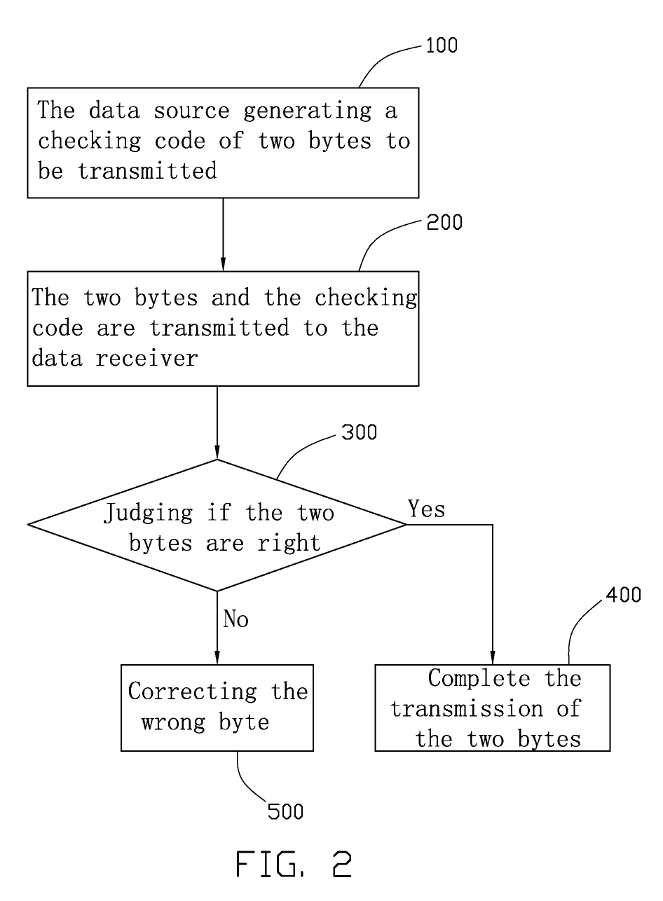

Referring to FIG. 2, when a set of data, such as “ASDFGZ” is to be transmitted from the data source 10 to the data receiver 20, the method includes the following steps.
Step 100: the data source 10 generates a checking code in binary form of the first datum “A” expressed as “1000001” and the second datum “S” expressed as “1010011”, and adds a parity bit to each to complete two 8-bit bytes representing the first datum and the second datum respectively. The checking code is generated by performing an exclusive ORs (XOR) on the binary forms of the first datum and the second datum, which in this example yields in binary form “0010010” and then a parity bit is added to complete a third byte. The parity bit of each of the three bytes is “0” or “1”. In this embodiment, if the number of bit “1” of a binary form is an odd number, the parity bit added thereto is “0”, if not, the parity bit is “1”.
Step 200: transmitting the first byte, the second byte, and the checking code of the first byte and the second byte from the data source 10 to the data receiver 20 via the transmission lines 1, 2 and 3 respectively.
Step 300: the data receiver 20 checks if the first byte, the second byte and the checking code are correct by means of parity checking, that is, to check if the number of the bit “1” in each of the first byte, the second byte and the checking code is in accordance with their corresponding parity bit, for example, if the datum “S” is wrongly received by the data receiver 20 as binary number “1011011”, it is wrong when the parity bit of the datum “S” is “1”.
Step 400: the transmission of the first byte, the second byte and the checking code of the first byte and the second byte is complete when no error is detected.
Step 500: if one of the first byte and the second byte is wrong, the data receiver 20 corrects the wrong byte automatically by performing an XOR on the binary forms of the other byte which is correct and the checking code of the first byte and the second byte, for example, if the datum “A” is right and the datum “S” is wrong, the data receiver 20 performs an XOR on the binary forms of the datum “A” and the checking code of the datum “A” and datum “S” to get a correct code of the datum “S”, and the transmission of the first byte, the second byte and the checking code of the first byte and the second byte is complete. If both of the first byte and the second byte are wrong, or the checking code of the first byte and the second byte is wrong, the first byte, the second byte and the checking code of the first byte and the second byte are transmitted again from the data source 10 to the data receiver 20.

To transmit the rest of the set of data, such as data “DFGZ”, the datum “D”, the datum “F” and the checking code of the datum “D” and the datum “F” are transmitted from the data source 10 to the data receiver 20 via the transmission lines 2, 3 and 1 respectively, then the datum “G”, the datum “Z” and the checking code of the datum “G” and the datum “Z” are transmitted from the data source 10 to the data receiver 20 via the transmission lines 3, 1 and 2, and so the cycle continues, thus improving data transmission speed of a data transmission system by using three transmission lines in rotating order. If all of the checking codes were transmitted via only the transmission line 3 for example, if the transmission line 3 becomes inoperable, then the checking codes must be transmitted via another transmission line that is also used for the datum. However, in the condition that all of the checking codes are transmitted via different transmission lines 1, 2 and 3 circularly, when two bytes and the checking code of the two bytes are transmitted via the transmission line 3, 1 and 2 respectively, if the transmission line 3 becomes inoperable, the data receiver 20 can calculate the byte it failed to receive via the transmission line 3 automatically, by performing an XOR on the binary forms of the checking code and the byte which is transmitted successfully via the transmission line 2, without retransmitting the two bytes again.

The data transmission method realizes high speed transmission by transmitting two bytes from the data source 10 to the data receiver 20 at a time and correcting incorrect bytes automatically instead of transmitting again when one of the two bytes is wrong.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A data transmission method used in a data transmission system, which has a data source, a data receiver, and first, second and third transmission lines connected between the data source and the data receiver, comprising:
the data source generating a checking code of a first byte and a second byte;
transmitting the first byte, the second byte and the checking code from the data source to the data receiver via the first, second and third transmission lines respectively; and
the data receiver judging if the first byte, the second byte and the checking code are right, if right, transmission of the first byte and the second byte is complete, if one of the first byte and the second byte is wrong, and the checking code is right, the data receiver corrects the wrong byte via the checking code.

2. The data transmission method as claimed in claim 1, wherein the checking code is generated by performing an exclusive ORs (XOR) on the binary forms of the first byte and the second byte.

3. The data transmission method as claimed in claim 1, wherein the data receiver judges if each of the first byte, the second byte and the checking code is right via a parity bit thereof respectively.

4. The data transmission method as claimed in claim 1, wherein the data receiver corrects the incorrect byte by performing an XOR on the binary forms of the checking code and the other byte, which is correct.

5. The data transmission method as claimed in claim 1, wherein the judging step further comprising:
if judging the first byte and the second byte are both wrong or the checking code is wrong, the data source transmits the first byte, the second byte and the checking code again to the data receiver.

6. The data transmission method as claimed in claim 1, further comprising: transmitting other checking codes of some other bytes which need to be transmitted via the first, second, and third transmission lines in rotation.
